(19) United States
(12) Patent Application Publication
(10) Pub. No.: US 2010/0315831 A1
(43) Pub. Date: Dec. 16, 2010

(54) LIGHTED OR SOUND TIP FOR MOBILITY DEVICES AND METHOD OF USING

(76) Inventors: David A. Durfee, N. Scituate, RI (US); Jon Smyth, Newport, RI (US)

Correspondence Address: BURNS & LEVINSON, LLP, 125 SUMMER STREET, BOSTON, MA, 02110, US

(21) Appl. No.: 12/648,038

(22) Filed: Dec. 28, 2009

Related U.S. Application Data
(63) Continuation of application No. 12/048,851, filed on Mar. 14, 2008, now abandoned.
(60) Provisional application No. 60/907,039, filed on Mar. 16, 2007.

(51) Int. Cl. G02B 6/00; F21L 4/02

(52) U.S. Cl. 362/551; 362/184

(57) ABSTRACT

A tip for a mobility device which is capable of providing light and/or sound to aid in the safety of the user of the mobility device.

This application is a continuing application claiming priority to a U.S. Utility application Ser. No. 12/048,851, filed on Mar. 14, 2008, which in turn claims priority to a Provisional Application Ser. No. 60/907,039, filed on Mar. 16, 2007, both applications are incorporated herein by reference in their entirety.

### FIELD OF INVENTION

The present invention relates generally to the field of mobility devices and, more particularly, to tips for use on the end or ends of mobility devices.

### BACKGROUND OF THE INVENTION

Many people have the need for mobility devices to help them move. Examples of mobility devices, although not limited thereto, include canes, walking sticks, crutches and walkers. Tips are affixed to the end of these mobility devices and make contact with an appropriate surface in order to provide stability for a user.

### SUMMARY OF THE INVENTION

The invention is a tip or member for removable or permanent attachment to the end or ends of a mobility device such as, but not limited to, canes, walking sticks, crutches and walkers. The tip includes, but is not limited to, a housing, a light and/or sound source, and a power source. The light and/or sound source and power source are within the housing and electrically connected to each other. The housing is adapted for receiving an end of a mobility device. Other embodiments of the tip are described in detail below and are also part of the present invention.

### BRIEF DESCRIPTION OF THE DRAWINGS

For a better understanding of the invention, together with other and further aspects thereof, reference is made to the accompanying drawings and detailed description, wherein:

FIG. 1 is a cross-sectional view of one embodiment of the tip of the present invention;

FIG. 2 is a cross-sectional view of another embodiment of the tip of the present invention;

FIG. 3 is a top view of one embodiment of the tip of the present invention;

FIG. 4 is a top view of another embodiment of the tip of the present invention; and

FIG. 5 is a cross-sectional view of another embodiment of the tip of the present invention.

### DETAILED DESCRIPTION

The invention is in the form of a tip, or member, that may be affixed to the end of a mobility device. Examples of mobility devices include, although not limited thereto, canes, walking sticks, crutches, and walkers. These mobility devices may be used to help people walk, although not limited to this purpose. The tip provides a light and/or sound source for safety or entertainment purposes, although not limited to these functions.

The tip, or member, of this invention may afford those with mobility disabilities a lighting or sound feature in order to aid the user in the area of safety, although not limited to this purpose. Since the tip may be removably attached to the end of a mobility device, the tip can be replaced several times during the life of the mobility device.

The user of a mobility device may wish to use light and/or sound sources adapted for different purposes. For example, although not limited to this embodiment, colored lights and sirens may be utilized for novelty purposes. The ability to change the tip is an advantage that allows the invention to be an “accessory”, which lowers the cost of the invention and permits it to be interchanged with a number of mobility devices.

The tip places the light source near the end of the mobility device, and therefore close to the surface that the mobility device contacts. In this way, the light source may illuminate nearby areas, yet is unobtrusive. The invention may improve a user's ability to see the area surrounding the mobility device in reduced light situations. The improved range of vision would be of greatest interest to those users with vision problems or who are using the mobility device in low light. The lighted tip improves the safety of the user of the mobility device by increasing visibility of the user on the most critical area, where the mobility device meets a surface to support the user.

The sound source may increase the safety of the user by providing an audible alert to the user and/or others people or animals nearby. This may be useful for bystanders who have poor hearing, visibility, or who are in poor light. The sound source may provide a warning that a user of a mobility device is nearby and to take caution.

The tip of the present invention makes contact with a supporting surface, providing gripping support for the mobility device and user. When the light and/or sound source is not in use the tip may appear to be a regular mobility device tip. The tip is easily replaceable and can retrofit already-existing standard mobility devices, greatly reducing the cost for the consumer. The tip does not require any special accommodation from a mobility device.

The tip or member housing may be constructed from a somewhat resilient material, or even slightly flexible material, such as rubber, although not limited to this embodiment. Rubber-like material allows the tip to be constructed such that it may be easily affixed to the end of a mobility device and provides gripping ability for the bottom of the tip. The housing may contain all of the other components of the invention so that it is a self-contained accessory, although not limited to this embodiment. If the end of the mobility device is hollow the tip housing may be constructed such that it may be partially disposed in that hollow area, although not limited to this embodiment. Bulky components such as a power source could then be stored out of the way in the hollow portion of a mobility device.

The light source may be constructed from Light Emitting Diodes (LEDs), although not limited to this embodiment. Other lighting sources may also be used including, although not limited to, a variety of wavelengths such as electroluminescent, incandescent, infrared, “black light,” or ultraviolet.

The sound source may be constructed from a digital sound generator, an annunciator, a bell, or any other device that makes sounds.

The invention may provide entertainment for those who require assistive mobility devices. The rationale is that this may help remove the stigma associated with the need to use such devices. The light source could be colored, or have any number of different combinations of colors. This may be of particular interest to younger people requiring a mobility device.

The light and/or sound source may be controlled by a logic controller, although not limited to this embodiment. The controller may control the light and/or sound source so that it/they can turn on in any number of patterns or durations, although not limited to this embodiment. The controller may determine how long each light and/or sound source remains on, in what sequence the source(s) are turned on, and the number of times a sequence is repeated. The controller may be constructed from one or more integrated circuit chips, field programmable logic devices, application specific integrated circuits, gate arrays, microcontrollers, or microprocessors, although not limited to these embodiments.

The light and/or sound source may also be controlled by a sensor or sensors so that it may be triggered by movement, contact with the ground, sound, or lack of ambient light, although not limited to these embodiments. A sensor may allow the device to operate based on when the mobility device is in use and not with explicit operator control, thus conserving battery life without affecting functionality and freeing the user of managing an additional aspect of a mobility device. A motion or pressure sensor or switch (such as an accelerometer, mercury switch, ball switch, spring switch, piezoelectric device, lever arm switch or pressure switch) may be used, although not limited to these embodiments. A sensor may be used as an input to the logic controller.

The logic controller and sensor may work together. This may be helpful if the light and/or sound source is/are controlled by a sensor and should be programmed to remain on for a period of time. For example, if the light and/or sound source is/are triggered by a motion sensor, the logic controller may have the light and/or sound remain on for a predetermined period of time before turning off. When the motion sensor is triggered again the light and/or sound will be reactivated. An electronic circuit constructed from active and/or passive electronic devices may be used to detect the use of the mobility device via the sensor/switch described above, although not limited to this embodiment. Upon sensing the use of the mobility device, the logic controller may determine the light and/or sound pattern and duration for the light and/or sound source. The logic controller and the sensor may be constructed on the same circuit board assembly.

The light and/or sound source may also be controlled by a switch that may be placed in the handle of the mobility device, although not limited to this embodiment. In this way the light and/or source, controlled by the logic controller, may be initiated by hand. This may provide novelty if a user would like to initiate a sequence of lights and tones for entertainment purposes, or even initiate flashing lights and sirens for safety reasons, although not limited to these embodiments. It is appreciated that a switch could be placed anywhere on the mobility device, or could even be operated by remote control, and it not limited to this embodiment.

The tip housing may be constructed from material having any variety of colors or designs, or may be constructed from a transparent material, although not limited to these embodiments. The tip may also be opaque and resemble a standard mobility device tip. To allow light and/or sound to escape the tip housing, openings in the housing may allow light and/or sound to be directed outward, although not limited to this embodiment. Light pipes may also be used to direct light because they increase the structural integrity of the tip and prevent water and dirt from getting inside the housing. Light pipes may be constructed from solid pieces of translucent or transparent material, although not limited to this embodiment. Light pipes provide for a solid housing structure yet also allow light to be directed outward. A tip may have a single, continuous light pipe, several independent light pipes, or any combination thereof. In addition, the light pipes may be constructed in any number of shapes or colors.

The invention may contain a power source for the light and/or sound source and any circuitry. The power source may be a battery or batteries, solar cells, or any other means for powering the light and/or sound source. The power source could incorporate a generator actuated through the use of the mobility device along with a capacitor or rechargeable battery. In this way, the device may be powered as it is being used. When powered by a battery, the battery or batteries may be installed permanently into the housing or may be incorporated into the design such that they could be easily replaced.

The present embodiment is described more fully hereinafter with reference to the accompanying drawings, in which the present embodiment is shown. The following configuration description is presented for illustrative purposes only and the scope of the invention should not be understood to be limited to these specific embodiments.

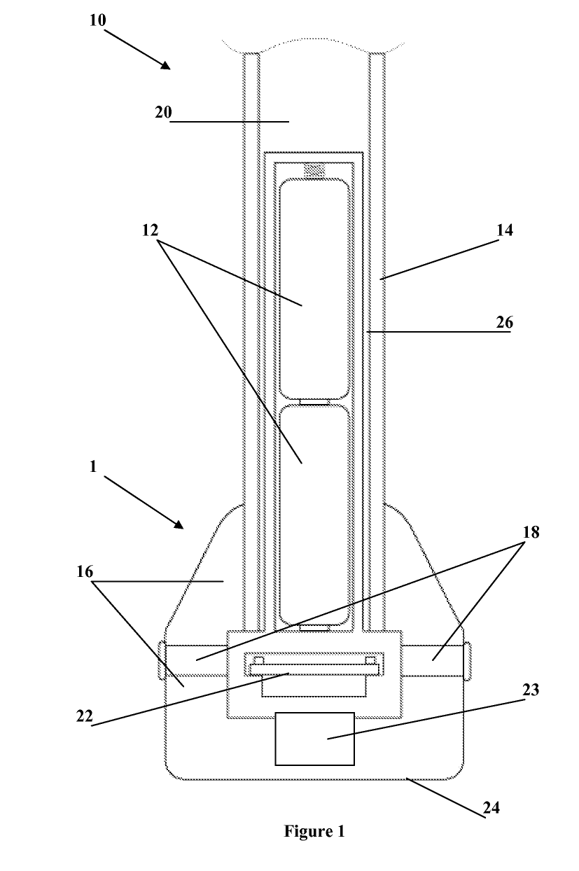

Referring now to FIG. 1, shown is a tip or member 1 of the invention employed on the end of a mobility device 10, such as a crutch, although not limited to this embodiment. The mobility device 10 may have a hollow end 20 with an outside wall 14. The tip 1 is made up of housing 16 which may be removably affixed or permanently affixed to the end of the mobility device 10 so that the bottom of the tip 24 makes contact with the ground, providing an appropriate grip to support the mobility device and user.

The tip housing 16 may contain a light source 22 which may be electrically connected to a power source. The power source may be a battery or batteries 12, although not limited to this embodiment. The batteries 12 may be stored in a battery compartment 26 portion of the tip housing 16 constructed so that it can be inserted into the hollow tube 20 of the mobility device 10. In this way a bulky power source may be kept out of sight and out of the way by making use of the hollow tube 20 of the mobility device 10.

Light may escape the tip or member housing 16 through light pipes 18, although not limited to this embodiment. Light pipes 18 may be constructed from transparent or translucent material, although not limited to these materials, which may guide the light to the exterior of the tip 1 in order to illuminate the area surrounding the tip bottom 24. The location of the light pipes 18 may also vary within the housing 16. There may be any number of individual light pipes 18 or a single continuous light pipe. The light pipes 18 may even be shaped to provide decorative designs. It is appreciated that light pipes may be constructed in any number of shapes, designs or colors.

A motion or pressure sensor 23 may be incorporated into the tip 1. The sensor 23 may be electrically connected to the light source 22 and batteries 12. In such a way, the sensor may activate the light source 22. The sensor may be comprised of a push-button or mercury switch, although not limited to these embodiments.

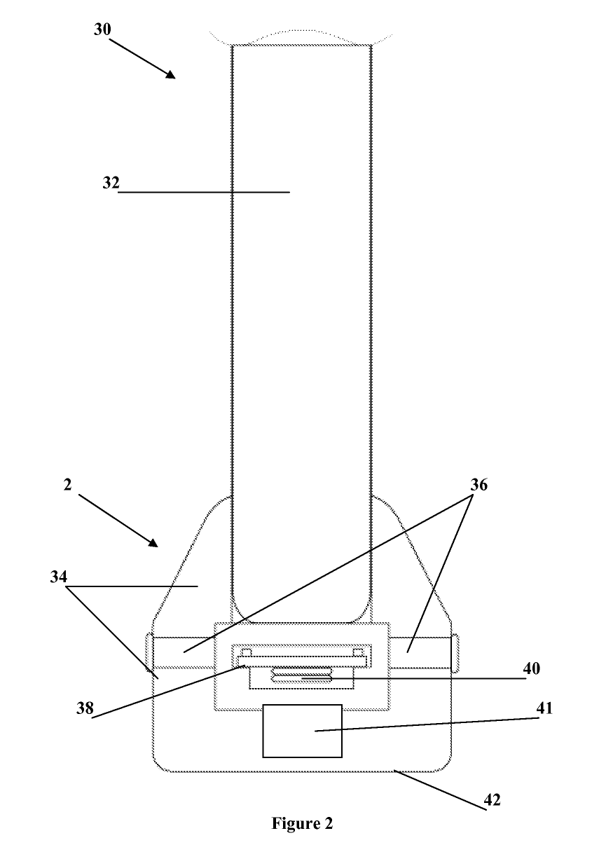

Referring now to FIG. 2, shown is another embodiment of a tip 2, or member, of the invention employed on the end of a mobility device 30. The mobility device 30 may have a solid portion 32 onto which the tip housing 34 affixes, although not limited to this embodiment. The housing 34 may have a light source 38 which is electrically connected to a small battery or batteries 40. Batteries commonly known as “coin” or “watch” batteries may be used, although not limited to these embodiments. The size of these small batteries 40 allows them to be placed in proximity to the light source 38 in the tip housing 34 so that it may be constructed in a compact shape. A sensor or switch 41 may determine when the light is turned on.

Light pipes 36 may be used to direct the light out of the lighted tip housing 34, which may otherwise be constructed from, although not limited to, opaque material. Light escaping the light pipes 36 illuminates the area adjacent to the bottom of the tip 42. This may help the user of a mobility device see where he or she is placing the mobility device end 30. For example, when walking up stairs in poor light conditions, the user of the mobility device such as a crutch, although not limited to this embodiment, will want to be sure that he or she is placing the bottom of the tip 42 on an appropriate stair in order to provide stability. The light source 38 and light pipes 36 may provide sufficient light to illuminate the area so that the user can be assured that the mobility device is resting on an appropriate surface.

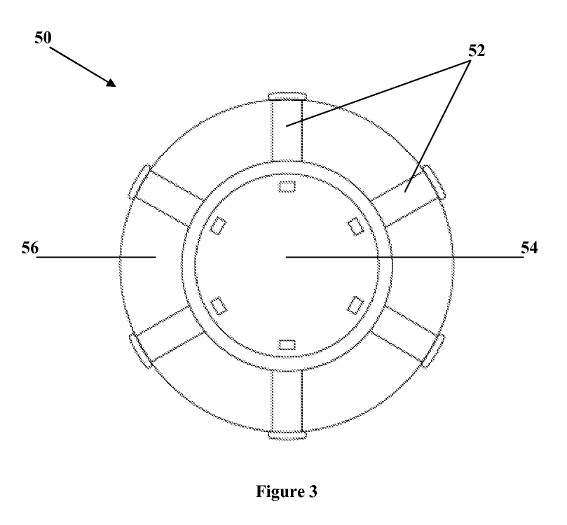

Referring now to FIG. 3, shown is a top view of one embodiment of the invention employed on the end of a mobility device 50. The mobility device 50 may have a round shaft 54, although not limited to this embodiment, onto which the tip housing 56 affixes. It is appreciated that the housing 56 may be either permanently or removably affixed to the shaft 54. The housing 56 may have a number of light pipes 52 which may be constructed from sections of transparent or translucent material, although not limited to these materials, that direct the light radiating from the light source within the tip housing 56 to the surrounding area. It is appreciated that the number, placement and shape of the light pipes is not limited to this particular embodiment, but could encompass any number of configurations and combinations. For example, although not limited thereto, the lighted tip housing 56 may have one or more light pipes on one side imitating headlights and one or more brake lights on another side, imitating the light design of an automobile. In addition, the tip housing may take the shape of a car, plane, rocket, or some other shape, although not limited to these embodiments, which may be preferable to users such as children.

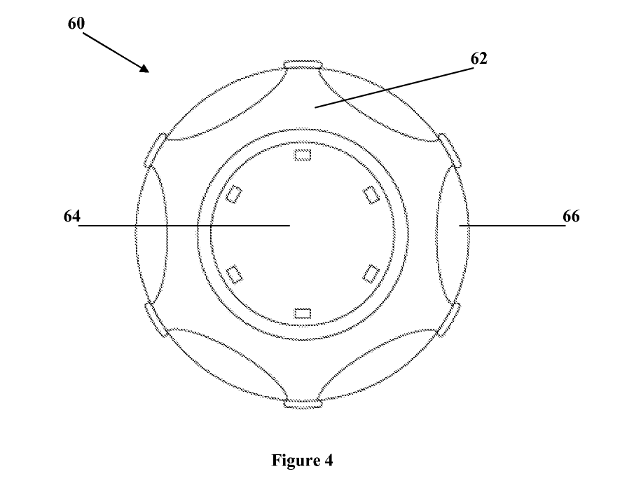

Referring now to FIG. 4, shown is a top view of another embodiment of the invention employed on the end of a mobility device 60. The mobility device 60 may have a round shaft 64, although not limited to this embodiment, onto which the tip housing 66 affixes. The housing 66 may contain a single, continuous light pipe 62 which directs the light radiating from the light source within the lighted tip housing 66 to the area outside. With the use of light pipes, a single light source, although not limited to this embodiment, can be directed in any number of directions to illuminate the area surrounding the tip.

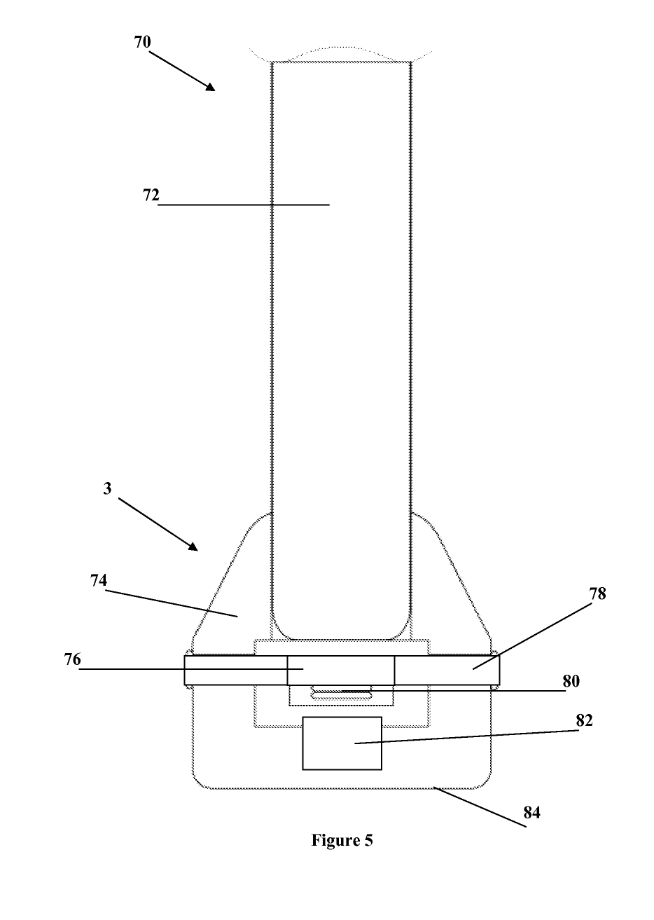

Referring now to FIG. 5, shown is another embodiment of a tip 3, or member, of the invention employed on the end of a mobility device 70. The mobility device 70 may have a solid portion 72 onto which the tip housing 74 affixes, although not limited to this embodiment. The housing 74 may have a sound source 76 which is electrically connected to a small battery or batteries 80. A sensor or switch 82 may determine when the sound is turned on. Openings 78 in the housing 74 may be used to allow the sound out. When the sensor or switch 82 is triggered, the sound source 76 may be turned on to provide a noise to nearby areas.

While the present invention has been described above in terms of specific embodiments, it is to be understood that the invention is not limited to these disclosed embodiments. Many modifications and other embodiments of the invention will come to mind to those skilled in the art to which this invention pertains, and which are intended to be and are covered by both this disclosure and the appended claims. It is intended that the scope of the invention should be determined by proper interpretation and construction of the appended claims and their legal equivalents, as understood by those of skill in the art relying upon the disclosure in this specification and the attached drawings.

What is claimed is:

1. A member for use with a mobility device, comprising
a housing having a first end and a second end;
said first end for receiving the end of the mobility device,
at least one light source,
a power source connected to said at least one light source,
and means for activating said at least one light source,
said at least one light source, said power source, and said means for activating are
disposed in said housing, and
said second end of said housing being in the shape of a tip.

2. The member of claim 1 wherein said housing further comprises an elongated component shaped to fit at least partially into a hollow end the mobility device.

3. The member of claim 2 wherein said power source is disposed within said elongated component.

4. The member of claim 3 further comprising at least one light pipe disposed in said housing that permits the light of said at least one light source to escape said housing.

5. The member of claim 4 further comprising a logic controller within said housing electrically connected to said power source that controls said at least one light source.

6. The member of claim 5 further comprising a sensor electrically connected to said power source that inputs to said logic controller.

7. The member of claim 6 wherein said sensor is a motion detector.

8. The member of claim 6 wherein said sensor is a pressure detector.

9. The member of claim 6 wherein said sensor is a sound detector.

10. The member of claim 1 further comprising a sensor electrically connected to said power source that controls said at least one of light source.

11. The member of claim 10 wherein said sensor is a motion detector.

12. The member of claim 1 further comprising a sound source.

13. The member of claim 12 wherein said sound source is a digital sound generator connected to said power source.

14. A member for use with a mobility device, comprising
a housing for receiving the end of the mobility device,
at least one sound source,
a power source connected to said at least one sound source,
and means for activating said at least one sound source,
said at least one sound source, said power source, and said means for activating are disposed in said housing, and
said housing being in the shape of a tip

15. The member of claim 14 further comprising a logic controller within said housing electrically connected to said power source that controls said at least one sound source.

16. The member of claim 15 further comprising a sensor electrically connected to said power source that inputs to said logic controller.

17. The member of claim 16 wherein said sensor is a motion detector.

18. A method of using a tip comprising
affixing a tip capable of providing light onto the end of a mobility device,
using the light generated by the tip to illuminate the area around the tip.

19. A method of using a tip comprising
affixing a tip capable of providing sound onto the end of a mobility device,
using the sound generated by the tip to provide a noise to the area around the tip.

20. A mobility device, comprising
a supportive structure,
and a tip affixed to an end of said supportive structure,
said tip comprising
a housing for receiving the end of the supportive structure,
at least one light source,
a power source connected to said at least one light source,
and means for activating said at least one light source,
said at least one light source, said power source, and said means for activating are disposed in said housing.
